(19) United States
(12) Patent Application Publication
(10) Pub. No.: US 2026/0185187 A1
(43) Pub. Date: Jul. 2, 2026

(54) LITHIUM CAPTURE DEVICE

(71) Applicant: ENERGY EXPLORATION TECHNOLOGIES, INC., Austin, TX (US)

(72) Inventors: Keith ANDERSON, Austin, TX (US); Richelle LYNDON, Austin, TX (US)

(73) Assignee: ENERGY EXPLORATION TECHNOLOGIES, INC., Austin, TX (US)

(21) Appl. No.: 18/863,881

(22) PCT Filed: May 12, 2023
(86) PCT No.: PCT/US2023/022081

§ 371 Date: Nov. 7, 2024

Related U.S. Application Data
(60) Provisional application No. 63/341,294, filed on May 12, 2022.
(60) Provisional application No. 63/351,722, filed on Jun. 13, 2022.

(51) Int. Cl. C22B 26/12; B01D 39/16; B01J 20/08; B01J 20/28; C22B 3/24

(52) U.S. Cl. CPC C22B 26/12; B01D 39/1623; B01J 20/08; B01J 20/28038; C22B 3/24; B01D 2239/065; B01D 2239/0695

(57) ABSTRACT

A membrane for capturing lithium via adsorption can include a stretched film and at least one of woven or knitted fabric or a nonwoven mat of fibers and can be functionalized by including at least one of: polymers coextruded with lithium-adsorbing solids; polymers with monomers or comonomers containing carboxylic, ammonium, amino, epoxy, ester groups, or other groups that can serve as nucleation sites for crystallizing or precipitating solid adsorbents; polymers with monomers or comonomers containing 2023/220394 chelating agents (such as ethers, porphyrin, diketones, etc.); or polymers that have been functionalized with the above comonomers by a surface grafting technique. The functionalized sites of the membrane can respectively carry an aluminum-based additive (e.g., aluminum trihydroxide (ATH) and alumina (Al₂O₃)) with an affinity for lithium adsorption. In an embodiment, the

### RELATED APPLICATIONS

This application claims priority to U.S. Provisional Application No. 63/341,294, filed May 12, 2022, and U.S. Provisional Application No. 63/351,722 filed Jun. 13, 2022 both entitled “Lithium Capture Device,” the contents of which are hereby incorporated by reference in their entirety.

### BACKGROUND

Adsorption of lithium onto solid adsorbents is one of the ways that lithium can be recovered from liquids, such as salar brines, salt-lake brines, oil-field brines, bromine-plant tail-brines, geothermal brines, fracking brines, leachate from mining operations, effluents from industrial processes, or lithium-containing streams from battery recycling plants (henceforth, may simply be referred to as “brines”). The current lithium adsorption resins, be they in the bead (e.g., as produced by DuPont Water Solutions), granule (e.g., available from Sunresin New Materials), and/or extruded form (e.g., as developed by Eramet SA), can have slow intraparticle diffusion kinetics. As a result, the dynamic capacity of these resins is much lower than their equilibrium capacity, which makes lithium adsorption inefficient. Also, industrial columns with beds of these resins suffer from relatively high pressure drops, poor liquid distribution, and particle attrition. Further, it is difficult to completely drain industrial columns between the loading and elution steps, so column rinsing is not efficient. To exacerbate these limitations, lithium adsorption resins tend to be very expensive (e.g., more than $10,000/m³) and thereby quite costly to replace.

### DRAWINGS

The Detailed Description is described with reference to the accompanying figures. Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete and will fully convey the scope.

FIG. 1 is a schematic, side, cut-away view of a lithium capture device, in accordance with an embodiment of the present disclosure.

FIG. 2 is a photomicrographic view of a porous UHMWPE (ultra-high molecular-weight polyethylene) membrane for use in the embodiments of FIG. 1.

FIG. 3 is a schematic view of a photochemical grafting system capable of producing a treated membrane for use as the membrane shown in FIGS. 1 and/or 2.

FIG. 4 is an isometric, transparent view of a lithium capture device, in accordance with an embodiment of the present disclosure.

### DETAILED DESCRIPTION

The present application relates to membranes that may be used in a lithium capture device. These membranes may show increased selectivity and/or result in increased sequestration of lithium ions. These and more details will be provided below.

### Introduction

Based on the limitations of current lithium adsorption technology, there is a need for an inexpensive, small-footprint, high-capacity, easily rinsible, and/or low-pressure drop lithium-capture device that can selectively capture lithium from flowing streams. In an embodiment, the lithium capture device can be similar to a filter-type configuration (e.g., cartridge filter, spiral-wound membrane, plate-and-frame filter, filter mat, etc.). Instead of a normal filter medium, however, the medium can be functionalized with a lithium-selective adsorbent to capture lithium from the flowing stream. The filter-like device is not particularly designed to capture solids or coalesce liquids in the same manner as normal filters. Rather, the medium in the lithium capture device can be designed to provide a porous support carrying adsorbents so that the adsorbents can be in intimate contact with lithium-containing streams, as these streams flow through the device.

A membrane-wound, ion-exchange filter cartridge has been developed that can adsorb heavy metal ions “instantaneously” from flowing streams. These cartridges can made by surface-grafting of styrene onto a porous polymer membrane, followed by sulfonating the resulting phenyl groups (Lee et al., U.S. Pat. No. 6,379,551). Several layers of the functionalized membranes can then be formed into a filter cartridge by wrapping around a core. These functionalized cartridges can have the same sulfonic acid groups as strong cation-exchange resins, but their ion-exchange kinetics are much higher (e.g., adsorption kinetics about four orders of magnitude faster than those of the macroreticular bead resins or those of the granular resins). These cartridges may be capable of capturing any cation but are most selective for multivalent cations. They are not specific to the adsorption of lithium.

Another approach to solve the problems with current lithium-selective resins is the use of composite fibers or filaments that contain a polymer plus embedded “Lithium-Ion Sieves” (LIS), as previously determined by other researchers. Examples of LIS include compounds such as Li_{1.6}Mn_{1.6}O₄ and H₄Ti₅O₁₂. These fibers or filaments can be formed into nonwoven mats through which liquids may flow. During adsorption of lithium, the LIS compounds exchange a proton for a lithium cation in the stream, and acids are generated. Also, acids are needed to regenerate the LIS. Due to their method of manufacture, the LIS compounds in the composite fibers or filaments are partially encapsulated by matrix defined by the polymer, so their lithium adsorption kinetics, while faster than those of resins, granules, or extrudates, are not as fast as desirable. Also, their dynamic capacity is less than their theoretical capacity. Another problem with composite fibers or filaments containing LIS is that the known LIS tend to dissolve over time.

Consequently, there is a need for a lithium capture device that can be used for lithium adsorption that can overcome some or all of the limitations of prior lithium adsorption components. In an embodiment, the present lithium capture device can incorporate supported lithium adsorbents in which a unit of the support can be a polymeric porous membrane, a porous and/or nonporous polymeric fiber, and/or a polymeric porous or nonporous filament (herein generically called a “polymeric support”). In an embodiment, the polymer(s) used for such a polymeric support may be nonfunctionalized. In an embodiment, such a lithium-adsorption capture device can be smaller and cheaper and/or can have a higher utilization than the fixed-bed lithium-adsorbing resins currently on the market.

In the case of a polymeric membrane support, it may be made of any suitable polymer that may be formed, stretched, punched, calendared, and/or otherwise processed into a porous sheet. In an embodiment, the polymeric membranes can be capable of being wound around a cylindrical core and/or be used in the form of a mat. Examples of suitable polymers are polyethylene, polyvinylidene fluoride, polyamides, polyesters, polysulfones, or mixtures and/or copolymers thereof. In the case of a polymeric fiber and/or a filament support unit, the polymeric support may be made of any suitable polymer that may be extruded through a spinneret or otherwise processed to make a fine fiber-or filament-like structure. The fibers and/or filaments can be capable of being wound around cylindrical cores, used in the form of a nonwoven mat, and/or spun into yarns. The resulting yarns, if employed, can be capable of being wound around cylindrical cores, used in the form of a nonwoven mats, and/or woven into porous fabrics that may then be wound around cylindrical cores or be used in woven mats. Examples of suitable polymers for fiber and/or filament supports are the same as those given for the membranes. Additionally, it may be appreciated by those skilled in the art that combinations of various types of polymeric supports may be used together, and the employment of one type is not exclusive.

Once a suitable polymeric support is obtained, it can be surface-functionalized to become a “functionalized support.” In one embodiment of this disclosure, the functionalized support can be achieved by surface-grafting of one or more functional groups onto the external and/or internal the surfaces of the support by surface-grafting techniques, as known to those skilled in the art. With surface grafting, many different types of functional groups may be candidates for attachment to the polymeric support (e.g., one or more types of functional groups chosen for a given application). Examples of functional groups that may be surface-grafted include amino groups, carboxylic acid groups, ketone groups, sulfonic acid groups, anhydride groups, quaternary ammonium groups, phosphonic acid groups, phosphinic acid groups, etc. These functional groups may be further elaborated into other functional groups. For example, phenyl groups may be sulfonated to make sulfonic acid groups or phenyl groups may be chloromethylated to may chloromethylphenyl groups. With suitable chemistry, one skilled in the art may, through surface-grafting and subsequent chemistry, attach nearly any functional group onto a “polymeric support.” It may be appreciated by those skilled in the art that the production of the functionalized support may be done batchwise or continuously, as recognized in the art.

In general, the initially prepared “functionalized supports” are not capable of selectively adsorbing lithium themselves. They tend to need to be further processed to make them “lithium-selective adsorbents.” In an embodiment, the lithium capture device can utilize aluminum-based additives, such as intercalating lithium trihydroxide (ATH) and/or alumina (Al₂O₃), to facilitate the lithium capture/adsorption. In one embodiment, groups such as quaternary ammonium groups or carboxylic acid groups can be used as nucleation sites to nucleate aluminum trihydroxide crystallites or amorphous aluminum trihydroxide from aluminum trihydroxide solutions. These aluminum-containing solids may be converted into materials that can selectively intercalate lithium chloride by contact with a lithium-containing brincs, as previously discovered. In one or more embodiments, crystals of intercalating ATH can be grown by nucleation onto an active microporous or macroporous membrane.

In one embodiment, the functional groups, particularly carboxylic acid groups, may be produced without grafting, but by a different mechanism. In an embodiment, the functionalization can be achieved simply by an oxidative treatment of the membrane, fiber, and/or filament with one or more oxidizing acids or other oxidizing agents. One example of such an oxidizing agent is nitric acid.

### Example Embodiments

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

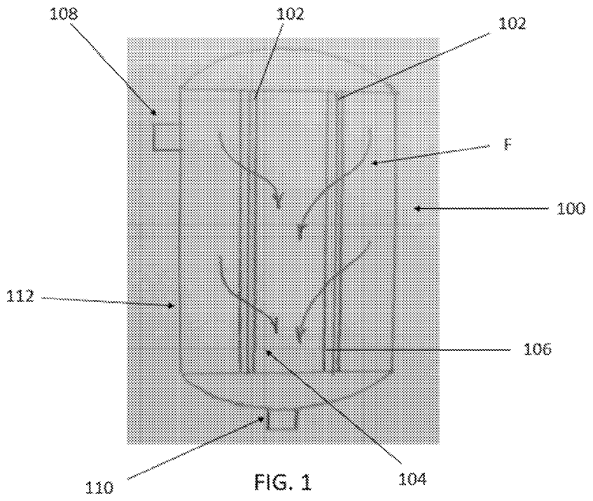

FIG. 1 illustrates a lithium-ion-exchange capture device 100, in accordance with an example embodiment of the present disclosure. In an embodiment, the lithium capture device 100 can be membrane-wound or fiber-wound. In an embodiment, a lithium capture device 100 can include multiple polymer components 102 (e.g., each made at least partially of fibers and/or a membrane). In an embodiment, a given polymer component 102 can be in the form of a polymer layer (e.g., membrane and/or a woven or non-woven mat of fibers). In an embodiment, the lithium capture device 100 can be in the form, for example, of a cartridge, a multi-layer and/or mat construct, and/or a spiral-wound component. In an embodiment, the layers 102 can further be wrapped or otherwise carried on support structure 104, which, per the illustrated example, may be in the form of a spindle. In an embodiment, the support structure 104 (in the form of a spindle in FIG. 1) may be hollow to facilitate fluid flow therethrough and may further include a fluid permeable support wall 106 (e.g., porous wall) against which the polymer components 102 can be wound and thereby carried and through which processed liquid (e.g., processed brine) may flow. In an embodiment, the lithium capture device 100 can further include a fluid (e.g., brine) inlet 108, a fluid outlet 110, and an outer shell/encasement 112. The outer shell/housing 112 can define a fluid-tight enclosure in which, for example, a brine may be processed. The lithium capture device 100 can be configured to accommodate a flow F therethrough, initiated via the fluid inlet 108, passing through the polymer components 102 and the support wall 106, and exiting via the fluid outlet 110. In an embodiment, a lithium-enriched fluid may exit via the fluid outlet 110.

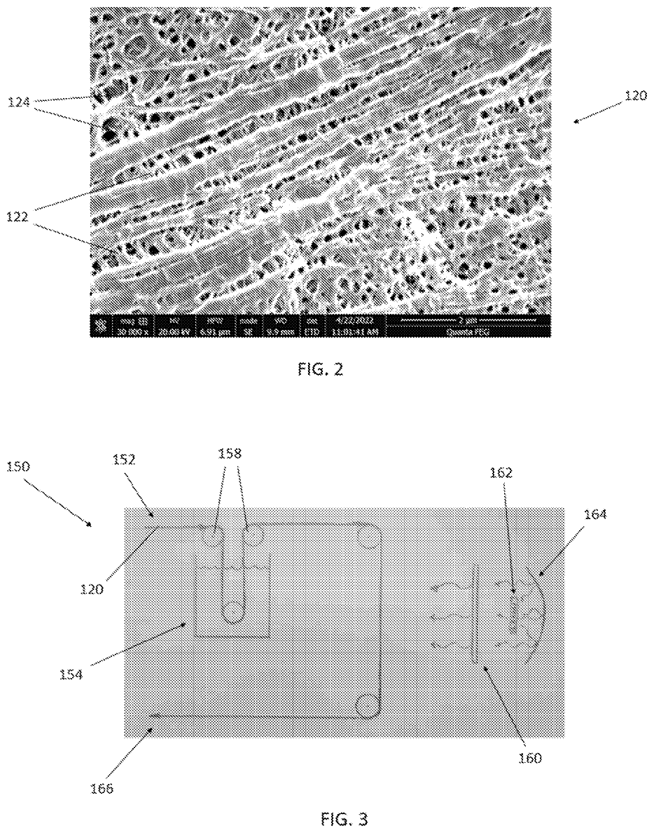

In an embodiment, as shown in FIG. 2, the membrane 120, used for a given layer/component 102, can include at least one of woven or knitted fabric or a nonwoven mat of fibers 122, together defining a plurality of pores 124 therebetween. In an embodiment, microporous materials have a diameter of less than two (2) nanometers (nm); mesoporous materials have pore diameters between 2 nm and 50 nm; and macroporous materials have diameters of greater than 50 nm. In an embodiment, the membrane 120 may be can be in the form of a macroporous membrane.

In an embodiment, the lithium capture device 100 can rapidly adsorb lithium ions from a flowing stream. A lithium capture device 100 can have adsorption kinetics faster than those of the macroreticular bead resins. In an embodiment, the adsorption kinetics can be more than an order of magnitude higher (e.g., upwards of 3 to 4 times higher). A lithium capture device 100 can be smaller and cheaper and have higher utilization than the fixed-bed lithium-adsorbing resins currently on the market. In an embodiment, one or more lithium capture devices 100 can be retrofitted in a plant currently using fixed-bed adsorption technology.

In an embodiment, the lithium capture device 100 can accommodate the capture lithium, the ions of which are lighter and smaller than most other ions. To that end, the lithium capture mechanisms 100 (e.g., cartridges, mats, etc.) of the present disclosure can incorporate one or more chemistries that are amenable to lithium-ion capture. For example, the lithium capture devices 100 can utilize aluminum-based additives, such as intercalating lithium trihydroxide (ATH) and/or alumina (Al₂O₃), to facilitate the lithium filtration. In an embodiment, the lithium can be captured in the form of a lithium salt, such as lithium chloride (LiCl). In one or more embodiments, crystals of intercalating ATH can be grown by nucleation onto active sites, which can permit growth of nano-clustered ATH on functionalized cartridge fibers; or, alternatively, nano- or microcrystals of ATH or alumina can be grafted directly on such fibers. As a result, the adsorption of LiCl onto nano-clusters of ATH on the surface of the fibers can be extremely fast due to no internal or external diffusion limitations existing.

In one or more embodiments, crystals of intercalating ATH can be grown by nucleation onto an active macroporous membrane. The macroporous membrane can include a stretched film and at least one of woven or knitted fabric or a nonwoven mat of fibers and can be functionalized by including at least one of: polymers coextruded with lithium-adsorbing solids; polymers with monomers or comonomers containing carboxylic, ammonium, amino, epoxy, ester groups, or other groups that can serve as nucleation sites for crystallizing or precipitating solid adsorbents; polymers with monomers or comonomers containing chelating agents (such as cyclic ethers, porphyrin, a diamine, ketones, etc.); or polymers that have been functionalized with the above comonomers by a surface grafting technique. It is to be understood that any functionalized supports created through use of a chelating agent can need further processing to enable them function as a lithium-selective support. In an embodiment, these or other functional groups can serve as nucleation sites for other types of lithium-selective adsorbents, for example, as nucleation sites for LIS such as Li_{1.6}Mn_{1.6}O₄ and H₄Ti₅O₁₂.

Once the membrane, fiber, or filament has been made capable of adsorbing lithium, i.e., a “lithium-selective support,” it can then be put in a form configured to facilitate a liquid flow in intimate contact through or around the lithium-selective support. For purposes of this disclosure, we may refer to such devices containing lithium-selective supports as “lithium-selective devices.” In an embodiment, a given lithium-selective device may serve as a corresponding lithium capture device 100. In general, lithium-selective devices can resemble filters. Examples of such devices include cartridge filters, a spiral-wound filtering elements, a plate-and-frame filters, leaf filters, even simple filter mats, etc.

Once the lithium-selective support has been installed into a “lithium-selective device” that allows for intimate contact of flowing liquid and the adsorbent, the devices can be arranged and operated in such a manner that the lithium-containing stream can be processed to recover lithium in a manner to maximize efficiency and/or cost effectiveness (e.g., value of system output relative to system cost (e.g., equipment and/or operating costs) of the system). It may be appreciated by those skilled in the art that one type or a combination of types of lithium-selective devices may be used, depending on the needs of the user and the characteristics of the lithium-containing stream. The use of a given type of lithium-selective device in a process is not exclusive.

In an embodiment, the lithium-selective supports in the lithium-selective devices can have a finite capacity for lithium. Therefore, such lithium-selective devices may be operated in a cycle. For instance, with a single device, there can be a loading or adsorption phase during which lithium is adsorbed. This loading phase can usually be followed by a washing and/or a blow-out phase during which the liquid is displaced by another liquid or a gas. Then, there can be a desorption and/or elution phase during which lithium is desorbed from the lithium-selective supports. Sometimes, there can be a further regeneration phase during which the adsorbent is regenerated. Upon desorption or elution and, optionally, regeneration, the lithium processing cycle can be repeated. In an embodiment, the washing or blow-out phase may be done concurrently or counter-currently to the feed flow. The wash may, for example, be pure water, a brine, or a solvent. The wash may be recycled and mixed with the feed to improve recovery.

The desorption or elution phase may be performed concurrently with or counter-currently to the feed flow. In the case of lithium-selective supports that have aluminum-based lithium intercalating compounds, the eluent used in the desorption phase may be pure water or a weak brine containing lithium chloride. If pure water is used, care can be taken to not totally deplete the lithium-selective support of LiCl; otherwise, the aluminum-based lithium intercalating compound may be damaged, and a regeneration step might be needed. Similarly, if pure water is used, a regeneration step may be employed to preemptively regenerate a given aluminum-based lithium intercalating compound (e.g., to help counteract any depletion).

In the case of lithium-selective supports that have LIS-type adsorbents, an acid can be used to regenerate the adsorbent. In remote areas, the acid may be generated by a small sulfuric acid plant, and/or the acid may be obtained by electrolytic salt splitting of a brine solution, including the eluate solution. The latter possibility provides the additional benefit of producing a solution of lithium hydroxide.

After lithium has been recovered from a given lithium-containing feed, the lithium-depleted stream or raffinate may need to be treated so that it can be disposed of. In an embodiment, this treatment can simply include a pH adjustment and filtering, but other adjustments to the raffinate stream may be necessary. The need for such post-treating is recognized and known how to be implemented by one who is skilled in the art.

The above process characteristics can generally employ several lithium-selective devices arranged in parallel and/or in series (e.g., for an industrial-scale operation). During operation, some of the devices 100 can be in the loading phase, others can be in the wash phase, others in the desorption phase, and others in the regeneration phase. By having multiple devices 100 operating in tandem, a near continuous process cadence can be achieved even with the distinct process steps in play. Switching values can be used to switch the influent and effluent streams between the lithium-selective devices, so that the process streams can flow essentially continuously but not necessarily with a constant composition. In an embodiment, a minimum configuration can include two lithium-selective devices arranged in parallel. In an embodiment, the lithium-selective devices 100 can also be arranged on a carrousel and/or valved appropriately to produce a simulated moving bed process. This arrangement can be expensive, but it can produce an essentially continuous effluent stream at an essentially constant flow as well as an essentially constant composition, which is sometimes advantageous.

As part of the processing arrangement, a given lithium-containing feed stream may be pretreated to remove organics, strip out hydrogen sulfide, precipitate iron, be filtered, be cooled or heated, and/or have its pH adjusted, for example, to maximize performance of the resulting lithium-selective device and/or to improve processing efficiency. The stream may also be processed to remove or dilute ions that might precipitate or interfere with the adsorption of lithium. Processes for accomplishing these pretreatment steps are known by those skilled in the art. In an embodiment, these steps can be performed in a continuous manner, for example, so that the equipment can have a reduced area footprint and/or be smaller in overall size.

In the case of a cartridge-type lithium capture device 100, one or several lithium capture devices 100 may be placed into a single shell/housing 112. The cartridge-type lithium capture device 100 can employ a plurality of lithium-selective membranes 120 that can be wound around the support structure 104 (e.g., in the form of a cartridge core/spindle) in one or more layer components 102. Lithium-selective fibers or filaments can be wound around the core as fibers or filaments 122 as is, or they can be spun into a yarn, which can then wound around the device core 104. In another embodiment, they can be woven into a fabric, which can then be wound around the core 104. In such a lithium-selective device 100, the liquid can flow radially into or out of the cartridge core 104, and the liquid can intimately contact the lithium-selective supports associated therewith.

In the case of a lithium capture device 100 featuring spiral-wound capture elements (not specifically illustrated), a single filtering clement or banks or rows of capture elements may be connected together in a parallel or series or in a mixed configuration. In the embodiment of a spiral-wound cartridge (not shown), the lithium-selective membrane(s) or woven mats of fibers or filaments can be spirally wrapped several times around a collecting pipe and may further employ spacers between layers (e.g., membrane(s) and/or mats). In an embodiment, the spiral-wound cartridge can be similar in construction to a regular cartridge except for the wrapping pattern used (e.g., spiral-wrapped instead of a straight, cylindrical wrap). In use, the spiral-wound cartridge can be configured such that the liquid is able to flow through the layers/components and pass into the middle collection pipe. As the liquid flows longitudinally and radially through the spiral-wound cartridge, the liquid can purposefully come in intimate contact with the lithium-selective supports due to the construction of the spiral-wound device. In an embodiment, a spiral-wound capture device may include a single housing/shell in which the layers/components can be contained and/or carried. It is to be understood that any of the variations for the lithium capture device may be used together, connected in parallel or series relative to one another.

Other constructions, as discussed above, can be available for the lithium capture device 100. In an embodiment of a plate-and-frame or leaf-type device, the liquid flow can be split into a plurality of substreams, and each substream can flow down and through one or more elements. Thus, the liquid can come into intimate contact with the adsorbents attached to the support. In another embodiment of the device, the membrane, fibers, and/or filaments can be formed into a mat through which the liquid flows.

It can be appreciated by those skilled in the art that by controlling the number of nucleation sites, the concentration, and/or temperature of the solutions from which the solid adsorbent originates, as well as other variables, that it is possible to grow crystallites or amorphous solids to a specific size range. For purposes of this disclosure, generally small particles (<1 micrometer in diameter) may be desired, so that diffusion limitations are minimized and dynamic capacity is high. Further, the process of nucleating and growing small particles directly on the functionalized support can be obviated by producing the small particles by a separate process, as known in the art, or by purchasing the small particles from a third-party producer. In this embodiment, the small particles can be surface-grafted onto the support by known means, such as by using a polycarboxylic acid as a grafting agent. If the particles are small enough, they may be mixed with the polymeric support and held in place simply by van der Waals forces. Such a process step can relieve the need for surface-grafting.

The at least one fabric or mat can thereby include at least one functionalized site. In an embodiment, the at least one given functionalized site can have at least one aluminum-based additive incorporated thereat (e.g., bonded to that site). In an embodiment, the functionalized macroporous membranes can be formed into a capture element 100, such as a candle filter, filter membrane, bag filter, cartridge filter, etc. In an embodiment, the functionalized macroporous membranes can be capable of handling large quantities of water with low pressure drops.

In an embodiment, lithium adsorbents can be provided on fibers as part of a replaceable fiber-wound lithium capture device 100. An intercalating aluminum trihydroxide (ATH) adsorbent can be advantageous, in part, because ATH is “generally recognized as safe” (GRAS), and is inexpensive to make. It generally does not leach out like the Mn-and Ti-based adsorbents do. Even if leaching of ATH occurred, it still would not be a health or environmental issue.

In an embodiment, a lithium capture device 100 can be made using a polymer grafting process. Thin sheets or membranes 120 of microporous ultra-high molecular-weight polyethylene (UHMWPE), for example, can be used to create a given set of polymer layer components 102. In an embodiment, one or more membranes 106 may be wrapped around or otherwise mounted/carried on the support structure 104, either directly (e.g., in contact with the support structure 104) or indirectly (e.g., onto another layer 102 of the membrane 106). The UHMWPE sheets or membranes 120 are commercially available nonwoven fabrics that are tough, thin, and can allow large fluxes of liquids at low pressure drops. Thus, UHMWPE sheets or membranes 120, as nonwoven fabrics, can include an array of fibers 122 and define a plurality of pores 124 between such fibers 122, as seen in FIG. 2. Such UHMWPE sheets 120 have already been used as a backing for selective ion-exchange membranes (SEMs).

In accordance with an example embodiment and in contrast to the bulk polymerization within the pores 124 of a UHMWPE sheet 120, a goal of producing a lithium-adsorbing device 100 can be to attach functionalized monomers to the outer surface of the UHMWPE membrane 120 and to the internal surfaces therein (e.g., defined by the fibers 122 internally facing one or more of the large pores (e.g., 100-1000 nm) that exist within such a membrane 120). This technique is known as “surface grafting.” In an embodiment, the monomers to be attached in the example process can be converted into pendant quaternary ammonium groups, pendant carboxylic acid groups, or pendant chelating groups. It is known that quaternary ammonium groups can be converted into seeds on which intercalating aluminum trihydroxide (ATH) can grow. Carboxylic acid groups are known to serve as nucleation points for common salt, so such groups can also serve as nucleation points for ATH crystallites. The carboxylic groups can also be made by oxidation with nitric acid without grafting on a monomer containing a carboxylic acid. Likewise, nitric and other oxidizing acids can create functional groups that can, in turn, be used as nucleation sites. Further, the pendant carboxylic groups can be elaborated into chelating compounds that can capture lithium via the entropy-driven ring-chelate effect. In addition to grafting monomers and growing crystals of ATH on them, nanoparticles can be directly grafted onto fibers within the UHMWPE membrane 120 using, for example, butane tetracarboxylic acid.

Since narrow-size-range nano-and micro-particles of aluminum-based additives, such as aluminum trihydroxide (ATH) and/or alumina (Al₂O₃), are commercially available, and they contain surface-OH groups, this grafting technology can be used to eliminate the nucleation and growth steps of forming ATH or alumina on the surface. It is known that ATH in any morphology may be converted into intercalating ATH that is capable of adsorbing LiCl. Likewise, alumina in any morphology can be converted into an intercalating ATH sorbent.

The polymeric membrane 120 (e.g., polymer with ester groups) can be fabricated with or without a support material, and with or without ATH nano-/micro-particle dispersed at various loadings. The membrane 120 can be produced via a casting or coating method and packed or stacked in a fiber, flat sheet, or spiral wound configuration. In one embodiment, following the fabrication of the polymeric membrane or ATH-loaded membrane 120, more ATH can be grown throughout the membrane 120, at the nucleation sites through two treatment steps: soaking the membrane 120 in a metal precursor solution and then soaking it in an alkaline solution. ATH nanoparticles can be used to improve particle adhesion and loading in the membrane 120. The ATH synthesis can be performed directly in a membrane cartridge or module 100 by circulating different solutions through the membrane 120. To prepare the lithium intercalated ATH, a hot concentrated LiCl solution can be circulated within the cartridge or module 100.

Various techniques are available by which surface grafting of monomers can be accomplished. The most common methods incorporate radiation, plasma, photochemical, and/or chemical initiation. In an embodiment, the most appropriate grafting techniques can be photochemical or chemical initiation, as they do not require the use of radiation or a plasma. Chemical initiation can be easier, but the grafting efficiency can be rather low.

A photochemical method, as generally known in the art, may be more conducive to commercialization. Photochemical methods generally do not require ionizing radiation (gamma radiation), high vacuum (plasma), and/or long reaction times (chemical initiation). They can be much easier to scale up and grafting efficiency can be high. For example, a simple, well-controlled, adjustable benchtop apparatus for continuous photochemical grafting using UV (ultraviolet) light, benzophenone as the photosensitizer, and atmospheric equipment can be used. The photochemical grafting system 150 may, as shown in FIG. 3, generally include a sheet input 152 for delivering a UHMWPE sheet 120; a container 154 for carrying a pre-soaking solution (e.g., acrylic acid in acetone); a series of delivery spools or rolls 158; an electric heater 160 (e.g., for heating the monomer); a UV lamp 162; and a parabolic reflector 164 (e.g., made of aluminum or other reflective metal); and an off-take 166 (e.g., for collecting the treated UHMWPE sheet 120). In an embodiment, the apparatus 150 can further include sources of treatment/reaction fluids (e.g., monomers, photosensitizers), delivery gas flows (e.g., inert/nitrogen), and/or temperature regulating components (e.g., heating and/or cooling sources; thermostats; etc.), etc., as needed to facilitate the UV surface functionalization (such further elements not shown). In an embodiment, only a portion of the apparatus 150 may be purged with nitrogen or another inert gas, and it can be maintained at a temperature of 65° C. or another suitable temperature. In contrast to the two-hour grafting times that can be needed for ion-selective membranes, photochemical grafting can be accomplished in 5-150 seconds (abbreviated “s” and/or “sec”), and, therefore, it is amenable to rapid processing. Further, other UV grafting units can be contemplated that accomplish the functionality of the system of FIG. 2 and are generally considered to be within the scope of this disclosure.

Although not part of the system illustrated in FIG. 3, the UV exposure section may be preceded with a further preheating section to promote diffusion of the monomer and photosensitizer deeper into a given UHMWPE sheet 120. By increasing the diffusion depth, it is possible to increase the utilization factor of a given treated sheet 120. In an embodiment, the preheating section may include one or more heat lamps (e.g., IR lamps) aimed toward the traveling UHMWPE sheet 120. In a preheating section, the given UHMWPE sheet 120 may be heated, for example, to a temperature above 65° C. or other baseline temperature in the treatment chamber, yet below any degradation temperature (e.g., melting temperature, chemical breakdown temperature, etc.) associated with the UHMWPE sheet 120.

It is to be understood that the lithium capture/adsorption device 100 need not take a cylindrical form (e.g., multiple sheets wrapped on a spindle). The lithium capture/adsorption device 100 can instead be in the form of a candle filter, a filter membrane, a fiber matt, a spiral membrane, and/or a bag filter. In an embodiment, the candle filter, the filter membrane, and/or the bag filter can incorporate a plurality of multiple polymer-grafted layers 102 (e.g., a layer stack), in order to increase the filtration capacity available in a given volume.

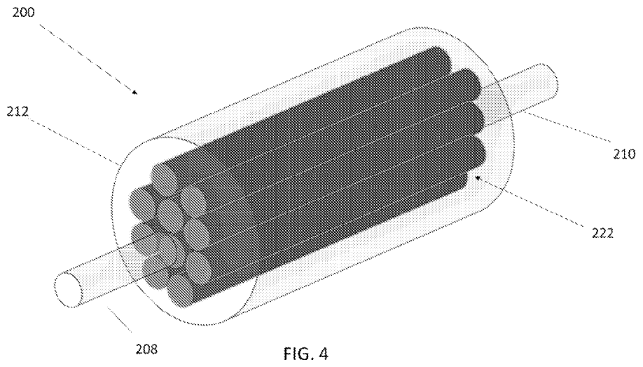

A further embodiment of the lithium capture/adsorption device, labelled lithium capture/adsorption device 200, with respect to the present disclosure is illustrated in FIG. 4. The lithium capture device 200 can include a fluid inlet 208, a fluid outlet 210, an outer shell/encasement 212, and a plurality of polymeric fibers 222. In an embodiment, the polymeric fibers 222 can be packed proximate to one another, coextending relative to one another. In an embodiment, such as shown, the polymeric fibers 222 may extend substantially parallel to one another along the axial direction of the outer shell/encasement 212. The outer shell/encasement 212 can enclose and otherwise carry the polymeric fibers 222 therein and may define a cylindrical container. It is to be understood that the polymeric fibers 222 can be treated and otherwise function in a similar manner as the membrane 120. In an embodiment, the polymeric fibers 222 may instead be wound (e.g., spirally) relative to one another (e.g., similar to a winding of yarn). As shown in FIG. 4, the polymeric fibers 222 can be employed without necessarily incorporating a spindle or other support. In an embodiment, the lithium capture/adsorption device 200 can be considered to be a sorbent cartridge.

Again, as stated above, the lithium capture/adsorption device 100 can offer multiple advantages over fixed-bed lithium-adsorbing resins. The lithium capture/adsorption device 100 can offer very fast kinetics relative to ion-exchange beads or granules, much better utilization of the capacity of the adsorbents, much more compact equipment, and/or greater flow rates therethrough than typical fixed-bed operations. Other advantages can exist as well, as can be derived from the above disclosure and related drawings.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A membrane configured comprising:
at least one of woven or knitted fabric or a nonwoven mat of fibers, the at least one of a given fabric or a given mat being functionalized by including at least one of:
polymers coextruded with lithium-adsorbing solids;
polymers with at least one of monomers or comonomers, the monomers or comonomers each including at least one of carboxylic, ammonium, amino, epoxy, or ester groups configured to serve as nucleation sites for at least one of crystallizing or precipitating solid adsorbents;
polymers with at least one of monomers or comonomers each containing chelating agents; or
polymers that have been functionalized by a surface grafting technique using comonomers including at least one of: a carboxylic, ammonium, amino, epoxy, or ester group or a chelating agent,
wherein the at least one fabric or mat thereby defines at least one functionalized site thereon, at least one given functionalized site having an aluminum-based additive associated therewith.

2. The membrane of claim 1, wherein the membrane is configured to adsorb at least one of lithium or a lithium salt.

3. The membrane of claim 2, wherein the membrane is incorporated into a lithium-adsorbing device, the lithium-adsorbing cartridge including at least one given membrane.

4. The membrane of claim 1, further comprising a stretched film, the stretched film carrying the at least one of a given fabric or a given mat.

5. A lithium-selective support, comprising:
a polymeric support material comprising at least one of a porous polymeric membrane material, at least one of a polymeric fiber or filament, a yarn including a plurality of at least one of the polymeric fibers or filaments, or a fabric of at least one of the polymeric fibers or filaments, the polymeric support material being functionalized, the at least one functional group configured to at least one of directly chelate lithium cations, be chemically modified to facilitate chelating of lithium cations, or serve as nucleation sites for the growth of small particles of at least one of crystalline or amorphous solids, the at least one of crystalline or amorphous solids, when present, configured to serve as lithium-selective adsorbents one of directly or with further treatment.

6. The lithium-selective support of claim 5, wherein the polymeric support material is functionalized by at least one of: surface grafting at least one functionalized group thereto, treatment with an oxidizing agent to form an oxidized group, attaching a crystalline or amorphous solid by surface grafting, or attaching at least one of a crystalline or an amorphous solid by van der Waals forces.

7. A lithium capture device, comprising:
a plurality of polymer-grafted components, each polymer-grafted component comprising at least one of a plurality of fibers or a membrane, each polymer-grafted component carried relative to the support structure, each polymer-grafted component incorporating a plurality of functionalized sites having an aluminum-based additive associated therewith, the given aluminum-based additive having an affinity for adsorbing at least one of lithium or a lithium salt.

8. The lithium capture device of claim 7, further comprising a support structure.

9. The lithium capture device of claim 8, wherein the support structure is a spindle, the polymer-grafted components wound around the spindle.

10. The lithium capture device of claim 7, further comprising an outer housing, the plurality of polymer-grafted components carried in the outer housing.

11. The lithium capture device of claim 7, wherein at least one polymer-grafted component comprises a membrane functionalized by including at least one of:
polymers coextruded with lithium-adsorbing solids;
polymers with at least one of monomers or comonomers, the monomers or comonomers each including at least one of carboxylic, ammonium, amino, epoxy, or ester groups configured to serve as nucleation sites for at least one of crystallizing or precipitating solid adsorbents;
polymers with at least one of monomers or comonomers each containing chelating agents; or
polymers that have been functionalized by a surface grafting technique using comonomers including at least one of: a carboxylic, ammonium, amino, epoxy, or ester group or a chelating agent.
